(19) United States
(12) Patent Application Publication
(10) Pub. No.: US 2012/0043029 A1
(43) Pub. Date: Feb. 23, 2012

(54) Dual Panel Window Shade Apparatus with Improved Bottom Weight Bar and Rail

(76) Inventors: Robert D. Gaskill, Bolingbrook, IL (US); Ernest DiSilvestro, Itasca, IL (US)

(21) Appl. No.: 12/860,380

(22) Filed: Aug. 20, 2010

(51) Int. Cl. E06B 9/44

(52) U.S. Cl. 160/121.1

(57) ABSTRACT

A dual panel adjustable light transmission shade apparatus for adjusting the amount of light passing through a window comprises a spool rotatably mounted in a canopy, and an opening in the canopy. A single piece of material forms opposed facing front and rear panels, and a bight is formed at the bottom of the panels. An upper portion of each panel is fastened to the spool at spaced apart locations on the outer surface of the spool. One of the panels moves generally vertically upward and the other panel moves generally vertically downward when the spool is rotated in one direction. A weight bar is lodged in the bight at the bottom of the panels to apply a downward force on the panels, and the weight bar rotates in the bight only when the panels are adjusted relative to each other.

### FIELD OF THE INVENTION

The present invention relates generally to window treatment apparatus, and more particularly to a vertically shifting dual panel roll-up window shade apparatus with an improved bottom weight bar and rail assembly to bring and hold the panel surfaces together as close as possible when the panels are extended.

### BACKGROUND OF THE INVENTION

Window treatments are well known. In addition to aesthetic features, window treatments also provide privacy, protection from sunlight, and thermal insulation. U.S. Pat. No. 58,668 to Morris, discloses a double panel curtain window treatment, where a pair of panels, when extended, are spaced apart by a distance equal to the diameter of the upper roller to which each panel is attached. The two panels extend from the two different sides of the upper roller. Each separate panel is connected along bottom portions thereof by tacking to a bottom block. Each of the panels includes a series of aligned apertures. When the upper roller is rotated a small amount, the alignment of the apertures in each panel changes, adjusting the passage of light and air through the panels. The Morrison patent does not disclose a bottom weight bar in a housing or rail assembly that applies different tension forces on the shade panels when the shade panels are lifted together as compared to when the shade panels are shifting vertical positions relative to each other.

U.S. Pat. No. 2,280,358 to Tietig discloses a pair of window shade panels disposed either on a single roller or on a pair of rollers, whereby a small movement of one panel relative to the other panel will act to exclude light wholly or partially. In one embodiment, the panels comprise polarized elements which block light when the panels are in register with each other. As the polarized portions are moved further apart from registration, the amount of light that passes through the panels changes. In another embodiment, alternate opaque and transparent strips or sheets are employed. An elastic strip is provided on either one or both of the sheets so that the panel having the elastic strip can be moved relative to the other panel without rotating the rollers. The Tietig patent does not disclose a bottom weight bar or rail assembly nor a dual panel window shade comprising a single piece of shade material.

U.S. Pat. No. 6,189,592 to Domel discloses a single piece dual panel adjustable shade having one upper end attached to a moveable roller tube, and the other upper end attached to a stationary, non-rotating tube or head rail. To weight the shade, Domel discloses a cylindrical metal or plastic rod in the bight formed at the bottom of the dual shade panels. As one of the shade panels is rolled onto the moveable roller tube, the rod in the bight continually rotates, causing the shade panels to wear out from the added friction caused by the rotating rod. Domel does not teach a combination single-piece, dual panel shade with a weight bar or rail assembly, wherein the weight bar only rotates a small increment when the shade panels are shifted relative to each other, but does not rotate against the panel fabric when both shade panels are raised simultaneously.

A transitional shade system is commercially available from Lafayette Venetian Blind, Inc. of West Lafayette, Ind. 47496 and sold under the brand name “Allure™.” The Allure shade system includes a weight rail at the lower portion of a retractable and adjustable shade, with a large weight bar rotatably mounted in a fixed vertical position relative to the weight rail between two fixed end caps of the rail. The Allure weight bar is not vertically moveable within the weight rail, rotates at all times when the Allure shade is raised, lowered, or adjusted to vary light passage, and does not include a weight rail housing that maintains the two panels forming the shade in close proximity.

U.S. Pat. No. 6,651,720 to DiSilvestro and Gaskill, the same co-inventors of the present invention, discloses a dual panel vertically shiftable window treatment that does not include a bottom weight rod assembly, or a single piece shade material forming a bight between shade panels at the bottom of the panels.

Prior art window treatments are relatively complicated in construction and operation, and have the additional disadvantages discussed above. A need exists for a simple, easy to manufacture dual panel window shade made of a single piece of material in combination with a bottom weight bar and rail assembly that is easy to manufacture and install, and will not prematurely wear out the fabric comprising the shade panels.

### SUMMARY OF THE INVENTION

The present invention is directed to a, dual panel vertically shiftable window shade apparatus having the dual panels formed from a single piece of material, and an improved bottom weight bar and rail assembly. The apparatus includes a single piece of shade fabric doubled over to form a front panel and a rear panel. The panels have opposed and alternate opaque and translucent portions. A cord or chain controls the operation of the panels to lift both panels simultaneously as they are wound on a spool, or to shift one panel vertically with respect to the other to vary the amount of light passing through the shade. A canopy houses the panels when they are wound on the spool. The panels can be made, for example, from fabric, paper, vinyl or the like. The spool is mounted for rotation within the canopy. The upper portion of the panels are attached at radially separate locations on the outer surface of the spool. The lower end of the dual panels form a bight through which a weight bar extends. The weight bar also rotates in a bottom weight rail assembly such that the weight bar does not rotate as both panels are raised simultaneously. Further, the weight bar of the present invention is free to move vertically in a hollow portion of the rail assembly when the relative vertical position of each panel is adjusted.

In the illustrated embodiment, the respective panels extend from the spool and over a rigid guide surface, such as a smooth edge of the canopy. The panels hang generally downward from the spool, and the spool is selectively rotatable via a cord and a clutch mechanism to move the panels generally vertically simultaneously in either direction, or to move the panels relative to one another. For example, as one panel moves up, the other panel moves down, and vice versa. Changing the diameter of the spool affects the vertical offset shift dimension of the two panels.

In the illustrated embodiment the designs formed in the panels define alternate rows of translucent and opaque elements of material. For example, the front panel may comprise alternate rows of opaque portions, with sheer or scrim portions between the opaque design wherein light can pass through the sheer or scrim portions. The rear panel correspondingly includes sheer or scrim portions in alignment with the opaque design on the outer panel, and opaque designs in alignment with the sheer or scrim designs on the outer panel. As the spool is rotated, the corresponding sheer and opaque portions become offset with respect to one antoher, varying the amount of light which passes through the shade apparatus.

When the shade panels are rotated simultaneously around the spool, the weight bar and its associated rail assembly rise with the bight formed at the bottom of the two panels. During this operation, the weight bar does not rotate, and there is no wear to the panel material caused by the weight bar. When the spool is rotated incrementally to adjust one of the panels relative to the other and vary the light passing through the dual panel shade, the weight bar rotates only a relatively small amount in the bight. The surface of the weight bar slides across the inner surface of the panel fabric only a minimal amount, thereby causing no or minimal wear of the panel material.

### BRIEF DESCRIPTION OF THE DRAWINGS

FIG. 1 is a front elevational view of a single piece dual panel window shade apparatus with a bottom weight bar and rail assembly, showing a partial cut-away to reveal a portion of the rear panel, and illustrating alternate rows of translucent and opaque material forming the dual panel shade structure positioned to allow no or minimal light to pass through the shade apparatus;

FIG. 2 is a side elevational view of the window shade apparatus of FIG. 1;

FIG. 3 is a front perspective view of the window shade apparatus of FIGS. 1 and 2, showing the front panel in partial cut-away to expose a view of a portion of the rear panel, and showing the alternate rows of translucent and opaque material forming the dual panel structure in a position to allow a medium amount of light to pass through the shade panels;

FIG. 4 is a front perspective partial cut away view of the window shade apparatus of the present invention similar to FIG. 3, where the alternate rows of the translucent and opaque material in the front and rear panels forming the dual panel structure are positioned to allow the maximum amount of light to pass through the shade apparatus;

FIG. 5 is a sectional schematic view of the shade apparatus taken along line X-X of FIG. 1, showing the dual panels of the single piece shade material in a partially retracted position;

FIG. 6 is a sectional schematic view of the shade apparatus taken along line X-X of FIG. 1, showing both of the dual panels of the shade material fully extended, with the alternate rows of translucent and opaque shade material aligned as shown in FIG. 1 to allow no or minimum light to pass through the shade panels;

FIG. 7 is a sectional view of the shade apparatus taken along line X-X of FIG. 1, showing both of the dual panels extended downward from the canopy, with the alternate rows of translucent and opaque shade material having been moved relative to each other from the position shown in FIG. 6 to allow the maximum amount of light to pass through the shade panels;

FIG. 8 is a front and side perspective detail view of the bottom weight bar and rail assembly of the present invention, showing the positions of the weight bar and the bight of shade material when the shade is retracted onto the spool by raising both panels simultaneously;

FIG. 9 is a front and side perspective detail view of the bottom weight bar and rail assembly of the present invention, showing the positions of the weight bar and the bight of shade material when one of the panels is being moved relative to the other panel;

FIG. 10 is a cross-sectional view of an embodiment of the bottom weight bar and rail assembly taken along line Y-Y of FIG. 9;

FIG. 11 is a front detail cut-away view of the canopy, shade spool and panel guide surface of the present invention; and

FIG. 12 is a side detail view of the canopy, shade spool and panel guide surface of the present invention taken along line Z-Z of FIG. 11.

### DETAILED DESCRIPTION OF THE ILLUSTRATED EMBODIMENT

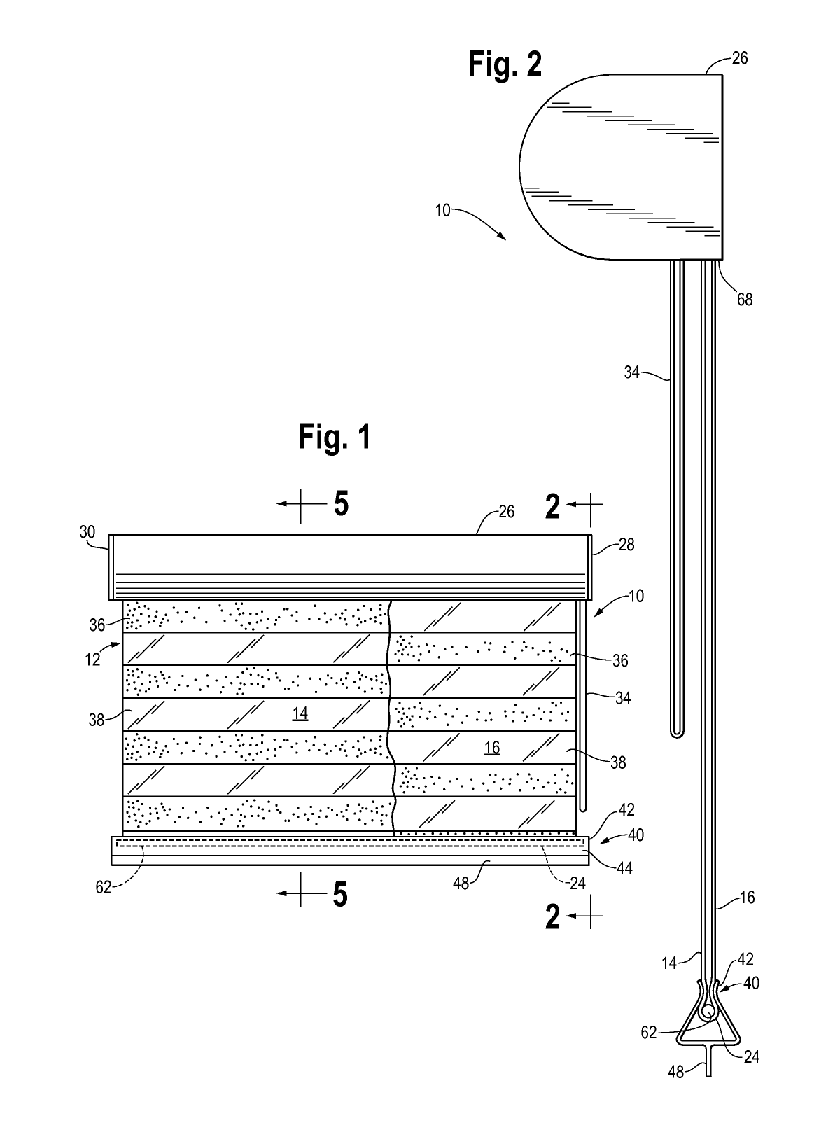

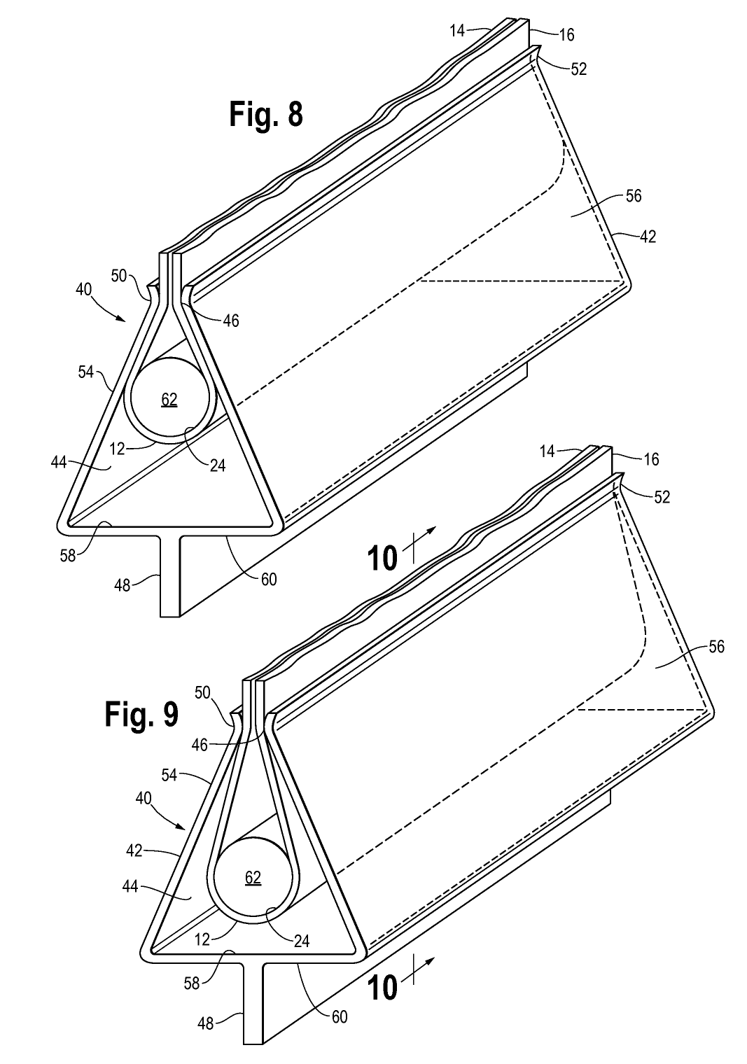

Referring to the drawings and FIGS. 1-7 in greater detail, the reference number 10 refers to a dual panel window shade apparatus. The shade apparatus 10 includes a single piece of material 12 formed in a loop and having a front panel 14 and a rear panel 16. As seen in FIG. 7, the upper portion of single piece of material 12 extends over and around the outer surface of spool or roller 18, and is fastened to spool 18 at two radially spaced apart locations, designated 20 and 22 in FIG. 7. At the bottom of shade material 12, panels 14 and 16 loop around to form a bight 24, as seen in FIGS. 8-10.

Referring to FIGS. 1-4, 7 and 11-12, the shade apparatus comprises a canopy 26 at the top of the apparatus. The canopy 26 is adapted to be fastened to a wall or sill over a window (not shown) as is known in the fastening art. The canopy includes opposed end flanges 28, 30. As shown in FIGS. 11 and 12, the ends of spool 18 are rotatably fastened to end flanges 28, 30 of canopy 26, such as by roller bearing 32. A cord or chain 34 is operatively connected to a clutch mechanism (not shown) to rotate spool 18 for vertical movement of front and rear panels 14, 16, either simultaneously to raise and lower the panels over the window (not shown), or to adjust the vertical position of panels 14 and 16 relative to each other, as will be explained.

Referring to the embodiment of the invention illustrated in FIG. 1, the single piece of shade material 12 that comprises front panel 14 and rear panel 16 includes alternate lateral portions of opaque material 36 and translucent or clear material 38. The front and rear panels 14, 16, when extended as shown in FIG. 2, are in close juxtaposition to one another, and the amount of light passing from the window through the shade material 12 is controlled by the positions of front panel 14 and rear panel 16 relative to one another.

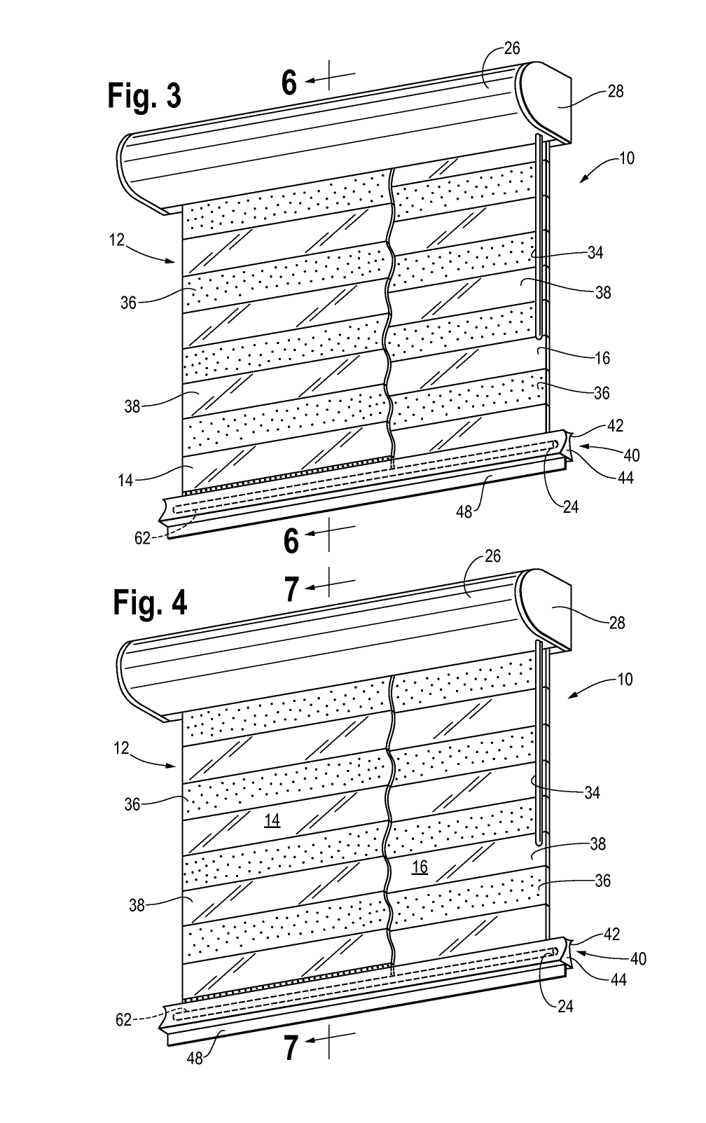

For example, in FIG. 1, each portion of opaque material 36 of front panel 14 is directly adjacent a portion of translucent or clear material 38 of rear panel 16. In this position, no or a severely restricted or minimal amount of light is allowed to pass through shade apparatus 10. FIG. 3 illustrates another position of front panel 14 and real panel 16, where the two panels have vertically and incrementally moved relative to each other, and the opaque material portions 36 and translucent portions 38 are partially adjacent one another. In this position of the front panel 14 and the rear panel 16, a medium or partial amount of light passes through the front and rear panels 14, 16 from the window located adjacent the shade apparatus 10.

Referring to FIG. 4, the front and rear panels 14, 16 are adjusted vertically and incrementally from their relative positions shown in FIG. 1 or 3, wherein the opaque material portions 36 of both the front panel 14 and the rear panel 16 are adjacent one another. The translucent portions 38 of each panel 14, 16 are also aligned adjacent each other. In the position shown in FIG. 4, the maximum amount of light can pass through the window and through the shade apparatus 10.

In the illustrated embodiment of FIGS. 1, 3 and 4, the opaque material 36 and translucent material 38 are shown as horizontally extending slat-like pieces of material. However, it is within the framework of the present invention to incorporate any positive design on one of panels 14, 16 and a corresponding negative design on the other of panels 14, 16. For example, the front panel 14 may comprise a plurality of circles as opaque portions of a design, while the remaining portion of the front panel 14 comprises translucent sheer or scrim material. Conversely, the rear panel 16 may comprise a corresponding series of circle designs of translucent sheer or scrim material, while the remaining portion of panel 16 is opaque. In this configuration, the front panel 14 may have opaque portions of the design on the surface thereof, with translucent sheer or scrim portions between the opaque design elements, with light passing through the translucent sheer or scrim portions. The rear panel 16 correspondingly includes translucent sheer or scrim design portions in horizontal alignment with the opaque design on the front panel 14, and opaque designs in horizontal alignment where the design on the front panel 14 is sheer. In an embodiment of the present invention, the opaque portions of one or the other panels 14, 16 are slightly oversized to provide total privacy when the panels are closed, as illustrated in FIG. 1.

Referring to FIGS. 1-10, a weight bar and rail assembly 40 is located at the bottom of shade apparatus 10 to provide a downward force on the single piece of shade material 12 as the panels 14, 16 are lowered, raised, and moved relative to each other to ensure the smooth and efficient operation of the shade apparatus 10, to stretch the material 12 and remove potential wrinkles in the material 10, and for other purposes to be explained.

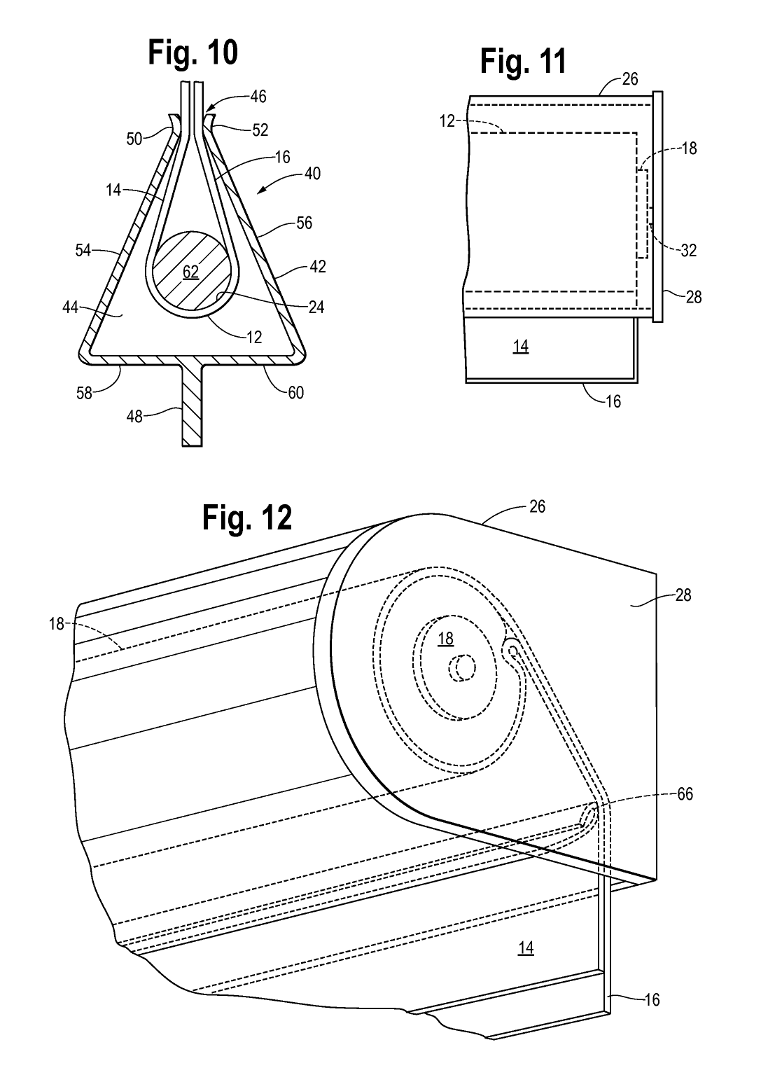

Weight bar and rail assembly 40 comprises a rail housing 42 extending the horizontal length of the bottom of panels 14 and 16. In the illustrated embodiment, the rail housing 42 has a hollow portion 44, and is somewhat triangular in shape with an opening 46 at the apex of the triangular housing. A downwardly extending flange 48 is located at the bottom of rail housing 42 to provide added weight to the housing. The opening 46 at the apex of rail housing 42 is formed by two vertically upstanding and horizontally extending flanges 50, 52 (FIGS. 8-10). Extending downward and outward from the bottom of each flange 50, 52 are side walls 54, 56 of rail housing 42. Each wall 54, 56 is connected to a respective bottom wall 58, 60, which are shown slightly angled in the embodiment shown in FIG. 10. The bottom walls may also extend horizontally, as shown in FIGS. 8 and 9. Hollow portion 44 of rail housing 42 is formed between side walls 54, 56, and bottom walls 58, 60.

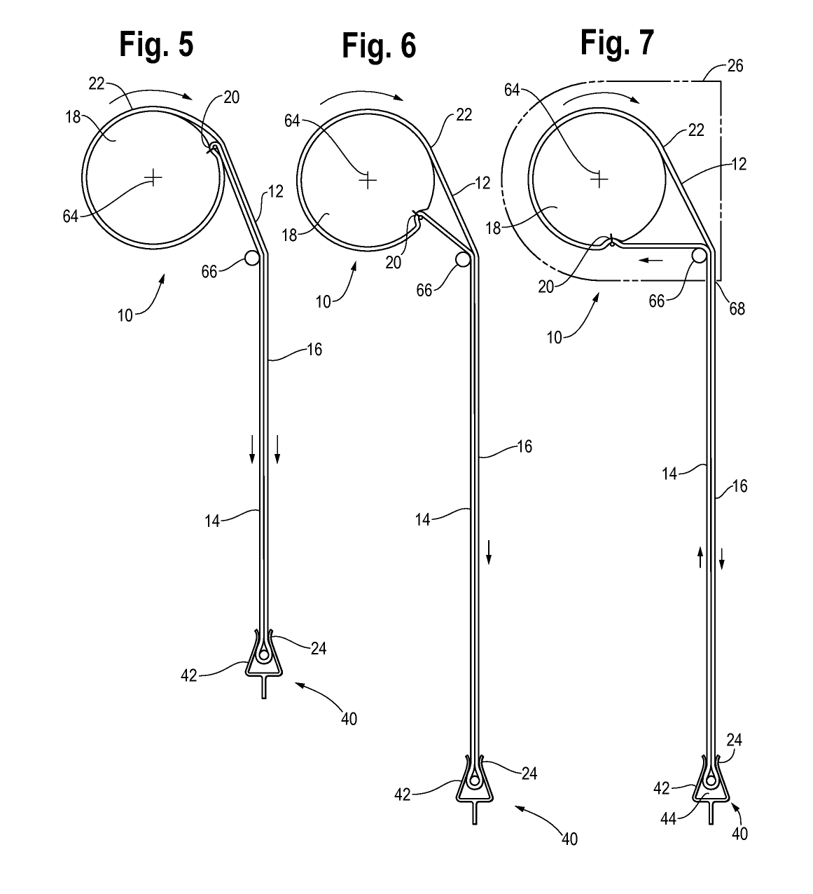

Weight bar or rod 62 is located in hollow portion 44 of rail housing 42. Weight bar 62 extends the full horizontal length of the bottom of panels 14 and 16, which panels are joined at bight 24. As seen in FIGS. 8-10, weight bar 62 is lodged in bight 24, with the bottom portions of front panel 14 and rear panel 16 extending around and in contact with weight bar 62. Front and rear panels 14, 16 also extend upward from contact with weight bar 62 and through opening 46 in rail housing 42. The upper ends of panels 14, 16 extend around spool 18, as seen in FIGS. 5-7.

Referring to FIGS. 8 and 9, weight bar 62 is freely inserted into hollow portion 44 of rail housing 42, and is capable of moving vertically upward and downward in hollow portion 44 depending on the operation of shade apparatus 10, as will be explained. The diameter of weight bar 62 is greater than the width of opening 46.

Referring to FIG. 7, the spool 18 is mounted within the canopy 26 for rotation about axis 64, indicated for example by arrow C, relative to the canopy 26. Rotation of spool 18 is manually, or automatically, controlled by cord or chain 34. A low friction guide surface 66 is rigidly attached to the canopy 26 to guide the exit of the panels 14, 16 from the canopy 26 through an opening 68 formed in a lower portion of the canopy 26 at or near the rear lower edge of canopy 26, directing the panels 14, 16 to a vertical plane in close proximity to each other and in close proximity to the window over which canopy 26 is installed.

The upper portions of panels 14, 16 are formed from the single piece of material 12. As seen in FIG. 7, the front panel 14 is rigidly connected to spool 18 at circumferential fastening location 20, and rear panel 16 is rigidly connected to spool 18 at separate fastening location 22 on the circumference of spool 18. The panels 14, 16 extend around spool 18 and out through opening 68 in canopy 26. Prior to reaching opening 68, the panels 14, 16 extend over, and are supported by guide surface 66.

In operation, the panels 14, 16 move generally vertically up and down relative to each other in the range of up to several inches. For example, as the front panel 14 moves down, the rear panel 16 moves up, and vice-versa, upon rotation of spool 18. Additional rotation of spool 18 will raise or lower both panels 14 and 16 simultaneously.

Referring to FIG. 5, starting with the position whereby both of the panels 14, 16 are wound around the spool 18, the spool 18 is rotated on axis 64 in the direction shown by arrow B through well known methods comprising manipulation of two strands comprising the cord or chain 34 (FIGS. 1, 2). The panels 14, 16 move in unison downwards over guide surface 66 and in front of the adjacent window as a result of weight bar 62 lodged in bight 24 at the bottom of each of the panels 14, 16. When the panels 14, 16 reach the position shown in FIG. 6, the panels 14, 16 are both in the fully extended position, and fastening locations 20 and 22 are in the spaced apart position shown in FIG. 6.

Referring to FIG. 7, to shift the position of the panels 14, 16 relative to each other, the spool 18 is rotated incrementally from the position shown in FIG. 6, as shown by arrow C in FIG. 7, whereby fastening location 20 moves arcuately away from guide surface 66, and fastening location 22 moves arcuately toward the guide surface 66. As shown in FIG. 7, the front panel 14 has thus moved vertically upward, while the rear panel 16 has moved vertically downward as single piece of material 12 moves around weight bar 62. This relative movement of the front and rear panels adjusts the position of opaque and translucent materials 36, 38, thus altering the amount of light passing through panels 14, 16.

To raise the panels 14, 16 away from the front of the window, the spool 18 is rotated in a direction opposite to that shown by arrow C in FIG. 7, whereby the panels 14, 16 are first moved into a position substantially co-extensive with each other, and then are both rewound upon the spool 18 and into the canopy 26, as shown in FIG. 5.

When spool 18 is rotated to raise panels 14 and 16 and the panels are wound around spool 18, the upward movement of the panels applies a force at bight 24 that causes weight bar 62 and the bottom portions of panels 14, 16 to rise in hollow portions 44 of rail housing 42. Referring to FIG. 8, panels 14 and 16 extend around weight bar 16 and exit rail housing 42 through the apex of the triangular housing 42 formed at opening 46. As weight bar 62 rises relative to rail housing 42, the outer surfaces of panels 14 and 16 are wedged into engagement with the interior surfaces of side walls 54, 56 of rail housing 42, thereby lifting weight bar 62 and rail housing 42 of weight bar and rail assembly 40 as spool 18 continues to rotate. This wedging action, acting in combination with the weight of weight bar 62, prevents panel 14 from moving relative to panel 16, and vice-versa, as the panels 14, 16 are being raised and wound around spool 18. The weight of weight bar and rail assembly 40 also keeps panels 14, 16 taut and adjacent one another as the panels are being raised in unison. The same combination of forces provided by weight bar and rail assembly 40 act to keep the panels 14, 16 in close proximity to each other as the panels are lowered from spool 18.

When panels 14, 16 are desired to be moved relative to each other to adjust the amount of light entering the room through the window, or the view from the room, as shown in FIGS. 7, 9 and 10, the panels 14, 16 are initially in their fully extended position (FIG. 6). The spool 18 is rotated incrementally in one circular direction or the other, as described above and shown in FIG. 7, such that fastening location point 20 moves away from (or towards) guide surface 66, and location point 22 moves towards (or away from) guide surface 66. During this motion, there is less, or no, force on weight bar 62 tending to pull the weight bar upward in hollow space 44 of rail housing 42. As a result, during the operation of shifting the vertical position of one panel 14, 16, relative to the other as seen in FIGS. 9 and 10, the weight bar 62 and bight 24 move downward away from opening 46 of housing 42, releasing the wedging action between the triangular configuration formed by the inside surfaces of side walls 54, 56 of rail housing 42 and panels 14, 16. This allows the bottom portions of panels 14, 16 to move over the surface of weight bar 62, or alternately cause weight bar 62 to rotate as the bottom portions of panels 14 and 16 engage and rotate weight bar 62.

As panels 14, 16 are raised and lowered as illustrated in FIG. 5, weight bar 62 does not rotate against the interior surfaces of single piece of material 12, thereby providing longer wearability of the material making up panels 14, 16. The weight bar 62 of the present invention rotates only the distance of the shift between panels 14, 16, and only during the shifting motion after the panels 14, 16 have been fully lowered over the window. This release of the previously described wedging action allows the panels 14, 16 in bight 24 to move substantially frictionlessly around weight bar 62, providing less wear and tear on the material comprising panels 14 and 16.

While the specification of the invention is described in relation to certain implementations or embodiments, many details are set forth for purposes of illustration. Thus, the foregoing merely illustrates the principles of the invention. For example, this invention may have other specific forms without departing from its spirit or essential characteristics. The described arrangements are illustrated and not restricted. To those skilled in the art, the invention is susceptible to additional implementations or embodiments and certain of the details described in this specification can be varied considerably without departing from the basic principles of the invention. It will thus be appreciated that those skilled in the art will be able to devise various arrangements that, although not explicitly described or shown here, embody the principles of the invention. They are thus within the spirit and scope of the invention.

We claim:

1. A dual panel adjustable light transmission window shade apparatus for adjusting the amount of light passing through the shade apparatus, comprising:
a rotatable spool having an outer surface, said spool rotatably mounted in a canopy, said canopy having an opening formed therein;
a piece of material forming opposed facing front and rear panels, the panels forming a bight at the bottom of the panels, an upper portion of said front panel fastened to said spool at a first fastening location, an upper portion of said rear panel fastened to said spool at a second fastening location, said first and second fastening locations disposed in a spaced apart relation on the outer surface of the spool;
one of said panels moving generally vertically upward and the other of said panels moving generally vertically downward when said spool is rotated in one direction; and
a weight bar lodged in said bight at the bottom of said panels, said weight bar applying a downward force on said panels, said weight bar rotating in said bight only when said panels are adjusted relative to each other.

2. The window shade apparatus of claim 1, further comprising:
a guide surface attached to said canopy adjacent said opening in said canopy, said front and rear panels extending downwardly over said guide surface as said front and rear panels extend away from said spool and outward from said canopy.

3. The window shade apparatus of claim 1 further comprising a weight bar and rail assembly, the weight bar and rail assembly including a housing and a hollow interior in the housing, the bight formed by the lower ends of the panels extending into said hollow space through an opening in the housing, said weight bar lodged in and supported by said bight.

4. The window shade apparatus of claim 3, wherein:
said housing comprises a generally triangular configuration forming the hollow interior of the housing.

5. The window shade apparatus of claim 4, wherein:
said opening is located at an apex of said triangular interior of said housing.

6. The window shade apparatus of claim 5, wherein:
said panels extend through said opening and downward into said hollow interior of said housing, said bight being located in said hollow interior of said housing; and
said weight bar is freely moveable in a vertical direction in said housing.

7. The window shade apparatus of claim 6, wherein:
said weight bar wedges said panels against interior walls of said housing when said weight bar and said bight are moved vertically upward.

8. The window shade apparatus of claim 3, wherein:
said housing includes a flange extending downward from said housing, said flange providing supplemental weight driving said housing in a downward direction.
